(19) United States
(12) Patent Application Publication
(10) Pub. No.: US 2026/0264340 A1
(43) Pub. Date: Sep. 10, 2026

(54) PLATE FOR HEATING DEVICES OF MACHINES FOR THE MACHINING OF PROFILED ELEMENTS MADE OF PLASTIC MATERIAL

(71) Applicant: Graf Synergy S.r.l., Nonantola, Modena (IT)

(72) Inventor: Nicola CASARINI, Nonantola, Modena (IT)

(73) Assignee: Graf Synergy S.r.l., Nonantola, Modena (IT)

(21) Appl. No.: 19/166,518

(22) PCT Filed: Mar. 14, 2024
(86) PCT No.: PCT/IB2024/052481

§ 371 Date: Sep. 18, 2025

(30) Foreign Application Priority Data
Mar. 20, 2023 (IT) 102023000005184

(51) Int. Cl. B29C 65/22; B29C 65/00

(52) U.S. Cl. CPC B29C 65/22; B29C 66/52431

(57) ABSTRACT

The plate (1) comprises a substantially plate-shaped main body (2) provided with a coupling surface (3) which can be coupled to a resistance assembly (21) of a heating device (20) and with a working surface (4), opposite the coupling surface (3), intended to contact an area to be welded of a profiled element (P) made of plastic material and provided with a series of grooves (5) and with a coating of at least one non-stick material, and at least one ferromagnetic portion (6) associated with the coupling surface (3), made of at least one ferromagnetic material and adapted to magnetically couple to a corresponding magnetic portion (22) of the resistance assembly (21).

### TECHNICAL FIELD

The present invention relates to a plate for heating devices of machines for the machining of profiled elements made of plastic material.

### BACKGROUND ART

In the field of machining of profiled elements made of plastic material, such as e.g. in the industry that deals with the manufacture of PVC window and door frames, it is known to join profiled elements together by welding to form more complex structures. In detail, in order to make a welding operation, the profiled elements are provided with an area to be welded, which is a transverse surface obtained by cutting the profiled element, which is heated until softening of the plastic material is obtained. The profiled elements are then joined together to bring the heated areas to be welded in contact with the associated molten plastic material which, when cooled, hardens to hold the profiled elements together.

This process is carried out by means of heating devices which consist of a resistance assembly, connectable to an energy source and which is intended to generate the heat necessary to melt the plastic material, and of a pair of plates, associated with the resistance assembly, at two opposite faces of the same, and intended to contact the profiled elements. The plates are fastened to the resistance assembly where there are relevant angular portions by means of fastening means of known type.

The heating device is generally configured to heat two profiled elements at the same time by means of heat transfer from the resistance assembly to the plates themselves.

In detail, the plates have a working surface provided with grooves in order to allow even and effective heating of the area to be welded.

In addition, the working surface has a non-stick coating to prevent an excessive amount of plastic material from sticking to the plate itself, leading to problems in the subsequent heating operations.

The manufacture of the plates involves laborious machining operations that result in high costs for the customer.

Specifically, the plates are first shaped, machined to make the grooves on the working surface and subjected to coating of the working surface with non-stick material, such as polytetrafluoroethylene.

The coating process involves very high temperatures (above 300° C.) that can deform the plate. In particular, at the end of the operations the plate is no longer perfectly planar but may be slightly curved.

This conformation results in less contact between the resistance assembly and the plate and worse heat transfer. In addition to this, the use of a plate that is not perfectly planar does not allow for effective heating of the profiled elements, as the working surface does not evenly contact the area to be welded of the profiled element, thus generating overly melted areas and/or insufficiently melted areas.

Therefore, after coating operations, the plates of known type undergo a further mechanical machining operation which involves manual riveting to restore them to a perfectly planar conformation.

Such manual machining operation contributes to higher costs for the plate manufacturing.

In addition, it should be specified that, as a result of prolonged use, the non-stick coating tends to spoil and requires periodic maintenance work in order to restore it, resulting in the already listed drawbacks.

### Description of the Invention

The main aim of the present invention is to devise a plate for heating devices of machines for the machining of profiled elements made of plastic material which allows reducing costs and timelines related to the manufacturing and/or maintenance of the same.

Another object of the present invention is to devise a plate for heating devices of machines for the machining of profiled elements made of plastic material which allows ensuring effective heat transfer from the heating assembly and which allows even heating of the profiled element.

Another object of the present invention is to devise a plate for heating devices of machines for the machining of profiled elements made of plastic material which allows the aforementioned drawbacks of the prior art to be overcome within the framework of a simple, rational, easy and effective to use as well as affordable solution.

The aforementioned objects are achieved by this plate for heating devices of machines for the machining of profiled elements made of plastic material having the characteristics of claim 1.

### BRIEF DESCRIPTION OF THE DRAWINGS

Other characteristics and advantages of the present invention will become more apparent from the description of a preferred, but not exclusive, embodiment of a plate for heating devices of machines for the machining of profiled elements made of plastic material, illustrated by way of an indicative, yet non-limiting example in the accompanying tables of drawings in which:

FIGS. 1-7 are views of plates according to the invention, in accordance with different embodiments;

FIGS. 8-11 are views of heating devices according to the invention, in accordance with different embodiments;

FIG. 12 is an axonometric view of a machine provided with plates according to the invention.

### EMBODIMENTS OF THE INVENTION

With particular reference to these figures, reference numeral 1 globally denotes a plate for heating devices of machines for the machining of profiled elements made of plastic material.

The plate 1 can be installed on a heating device of a machine for the machining of profiled elements made of plastic material.

In the context of this disclosure, the term “profiled elements made of plastic material” relates to elongated bodies, generally obtained by means of extrusion of plastic material or other techniques and which can be assembled together by welding. Welding profiled elements made of plastic material is known to be done by heating an area to be welded of the profiled element, that is, a transverse surface obtained by cutting the profiled element itself, until the plastic material is partly melted. The profiled elements are then joined together to bring the areas to be welded in contact with the relevant molten plastic material which, when cooled down, solidifies keeping the profiled elements together. The plate 1 comprises a substantially plate-shaped main body 2.

In the context of the present disclosure, the term “plate-shaped” means that the main body 2 has dimensions of length and width which are prevailing with respect to thickness and has a substantially planar or slightly curved development.

The main body 2 is provided with a coupling surface 3 which can be coupled to a resistance assembly 21 of a heating device 20 and with a working surface 4 opposite the coupling surface 3 and intended to contact an area to be welded of a profiled element P made of plastic material.

The coupling surface 3 is intended to contact the resistance assembly 21 to allow the heat generated thereby to be transmitted. It is necessary, therefore, that, in use, the coupling surface 3 perfectly adheres to the resistance assembly 21.

The opposite working surface 4 is responsible for the actual heating of the profiled element P where there is the corresponding area to be welded. For this purpose, it is desirable that, in use, the working surface 4 should be perfectly planar so as to allow the area to be welded to be heated evenly.

The working surface 4 is, in addition, provided with a series of grooves 5 adapted to allow an even distribution of heat to the profiled element P. The grooves 5 are arranged side by side, in a substantially even manner, along a direction substantially parallel to the plane of development of the working surface 4.

The working surface 4 also has a coating made of at least one non-stick material. The non-stick coating has the function of preventing excessive portions of the plastic material from sticking to the working surface 4 and ensures optimal heating of the subsequent profiled elements P as well.

The non-stick material is, e.g., polytetrafluoroethylene. It cannot, however, be ruled out that the non-stick material may be of a different type.

The main body 2 is made of metal material, preferably aluminum, which is a lightweight metal and easy to be machined.

The main body 2 has a maximum thickness of between 2 mm and 9 mm. In this regard, it is specified that the expression “maximum thickness” means the distance between the coupling surface 3 and the ridge defined by the grooves 5. This thickness gives strength to the plate 1 and limits the generation of deformations caused by the relevant manufacturing and/or maintenance process.

According to the invention, the plate 1 comprises at least one ferromagnetic portion 6 associated with the coupling surface 3, made of at least one ferromagnetic material and adapted to couple to a corresponding magnetic portion 22 of the resistance assembly 21. In use, when the plate 1 is mounted on the heating device 20, the ferromagnetic portion 6 is in contact with the magnetic portion 22.

In detail, the ferromagnetic portion 6 comprises an exposed face 7, facing outwards, and intended to contact the magnetic portion 22.

The interaction between the ferromagnetic portion 6 and the magnetic portion 22 generates a magnetic force of such an intensity that the plate 1 is made to adhere to the resistance assembly 21 and, in particular, to keep the coupling surface 3 in contact with the resistance assembly 21. In this way, the plate 1 is always perfectly planar, thus ensuring optimal heat transfer by the resistance assembly 21 and an even contact of the working surface 4 with the profiled element P.

Specifically, the magnetic interaction between the plate 1 and the resistance assembly 21 means that any deviations of the conformation of the plate 1 from planarity are fixed by the action of the magnetic force. As a result, any deformations of the plate 1 caused by the manufacturing and/or maintenance operations of the same are smoothed out by the magnetic interactions.

In this sense, the use of a ferromagnetic portion 6 and of a magnetic portion 22 allows reducing the costs and timing related to the manufacturing of the plates 1 and of the maintenance job thereon.

The interaction between the ferromagnetic portion 6 and the magnetic portion 22 also allows avoiding the use of traditional fasteners located between the plate 1 and the resistance assembly 21. It is, however, provided that the plate 1 can be further fastened to the resistance assembly 21 by means of traditional fasteners.

Conveniently, the ferromagnetic portion 6 is made completely or partly of ferromagnetic material, such as e.g. iron, nickel, cobalt or the like. The magnetic portion 22, on the other hand, is, e.g., a samarium-cobalt magnet or a neodymium-iron-boron magnet.

The main body 2 comprises at least one seat 8 formed on the coupling surface 3 and adapted to receive the ferromagnetic portion 6.

Conveniently, the plate 1 comprises fastening means adapted to fasten the ferromagnetic portion 6 to the main body 2 and which will be described in more detail later in this disclosure.

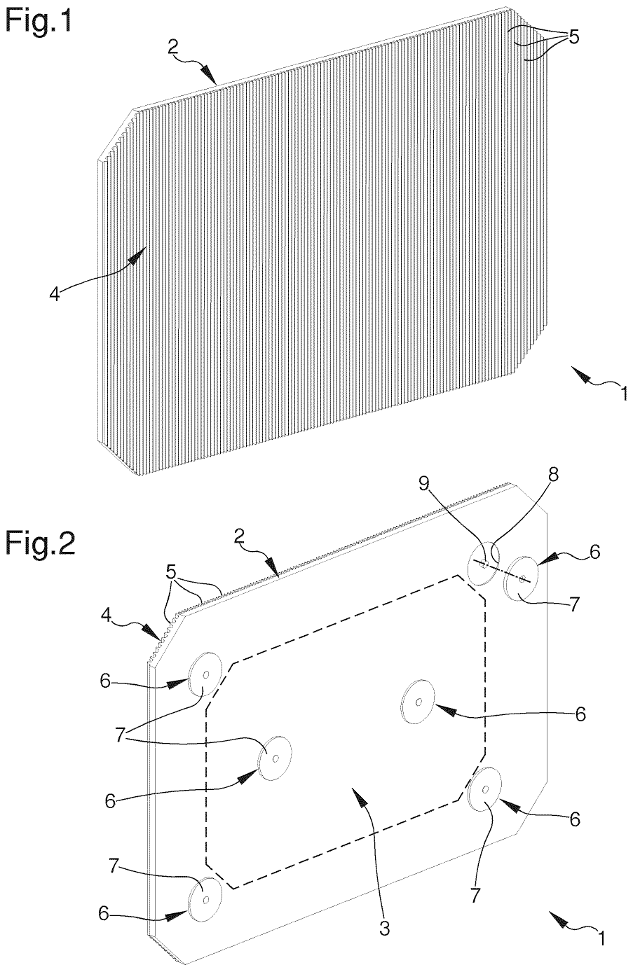

Different embodiments of the plate 1 are shown in FIGS. 1 through 7.

The embodiments shown in FIGS. 1 through 6 provide for the ferromagnetic portion 6 to have a substantially disc-shaped conformation. Specifically, the ferromagnetic portion 6 has a washer conformation, that is, disc-shaped provided with a central hole. Conveniently, the ferromagnetic portion 6 has a diameter of between 2.5 cm and 1.5 cm. It cannot, however, be ruled out that the ferromagnetic portion 6 may have a different conformation. For example, the ferromagnetic portion 6 may have a polygonal conformation or be of the type of an elongated bar.

Advantageously, the at least one ferromagnetic portion 6 comprises a central ferromagnetic portion 6 associated where a central area of the coupling surface 3 is located.

In detail, the coupling surface 3 comprises a central area and a peripheral area. The peripheral area develops along the perimeter of the coupling surface 3, within a distance of 4 cm from the edge of the coupling surface itself. The central area, on the other hand, develops centrally to the coupling surface 3, beyond 4 cm from the edge. In FIG. 2, the central area and the peripheral area are schematically bounded by a dashed line.

In this case, in combination with conventional fasteners located between the plate 1 and the resistance assembly 21, the central ferromagnetic portion 6 allows optimal adhesion of the coupling surface 3 to the resistance assembly itself.

Alternatively, the ferromagnetic portion 6 comprises a peripheral ferromagnetic portion 6 associated where the peripheral area of the coupling surface 3 is located.

The embodiments shown in FIGS. 1 through 6 provide for the plate 1 comprising a plurality of ferromagnetic portions 6.

The ferromagnetic portions 6 are arranged in various areas of the coupling surface 3 so as to allow, in use, optimum distribution of the magnetic forces and optimum adhesion of the plate 1 to the resistance assembly 21.

Conveniently, the ferromagnetic portions 6 comprise both peripheral ferromagnetic portions 6 and at least one central ferromagnetic portion 6.

In the present case, the ferromagnetic portions 6 comprise four peripheral ferromagnetic portions 6 and two central ferromagnetic portions 6. Even more specifically, the peripheral ferromagnetic portions 6 are arranged at the corners of the coupling surface 3.

The fact that the plate 1 may comprise a different number of ferromagnetic portions 6 arranged at different areas of the coupling surface 3 cannot, however, be ruled out. With reference to the preferred embodiment of the plate 1, shown in FIGS. 2 through 4, the ferromagnetic portion 6 protrudes from the coupling surface 3.

In the present case, the seat 8 is recessed with respect to the coupling surface 3, and the depth of the same (indicated by reference D1) is less than the thickness of the ferromagnetic portion 6 (indicated by reference D2). In actual facts, the seat 8 partly accommodates the ferromagnetic portion 6, which protrudes only for part of its thickness.

Alternatively, the seat 8 can be coplanar to the coupling surface 3 and, in actual facts, have zero depth. In this case, the ferromagnetic portion 6 protrudes for its entire thickness.

At the same time, the resistance assembly 21 comprises a housing 23 adapted to house the magnetic portion 22, wherein the housing 23 is configured to receive at least part of the respective ferromagnetic portion 6 so as to ensure the contact between the resistance assembly itself and the coupling surface 3. The characteristics of the resistance assembly 21 will be described in more detail later in this disclosure.

Such a conformation of the seat 8 and of the housing 23 results in the establishment of an interaction, not only magnetic but also mechanical, which allows the plate 1 to be held in a predefined position and avoids transverse movements that could cause the ferromagnetic portion 6 and the magnetic portion 22 to move away from each other and, consequently, the detachment of the plate 1 from the resistance assembly 21.

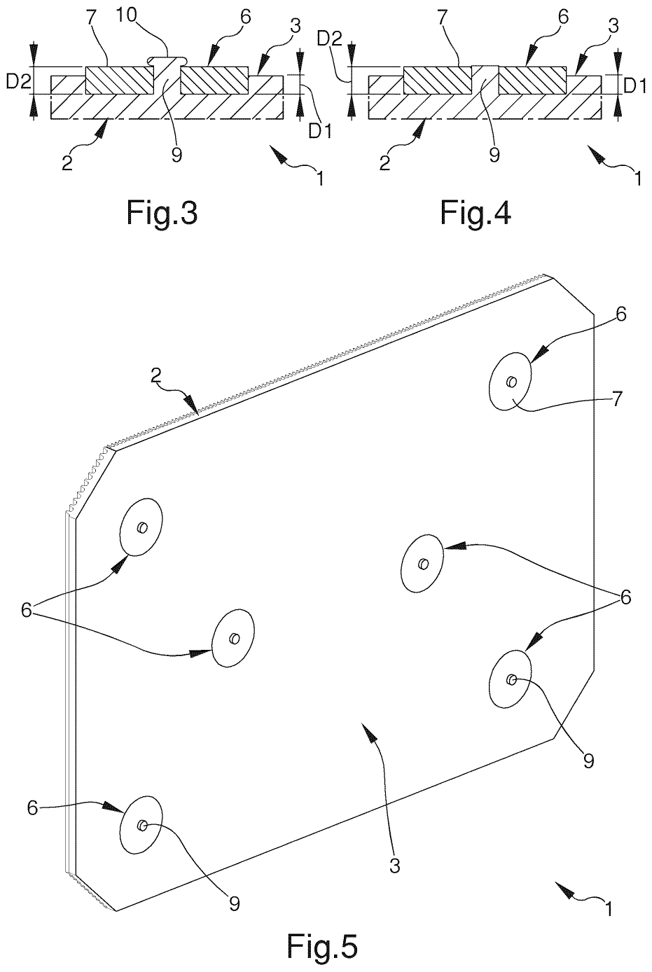

FIGS. 3 and 4 also show in detail some possible embodiments of the fastening means located between the ferromagnetic portion and the main body 2.

Advantageously, the fastening means may comprise at least one of: interlocking means, screwing means, adhesive means, rivet means or punching means.

In FIG. 3, rivet means are shown. In detail, the fastening means comprise a pin 9 defined within the seat 8 around which the ferromagnetic portion 6 is threaded.

The pin 9 defines an interlocking coupling with the hole of the ferromagnetic portion 6, thus helping keep the latter inside the seat 8.

In accordance with the embodiment shown in FIG. 3, the pin 9 has greater length than the thickness of the ferromagnetic portion 6. Once the ferromagnetic portion 6 is inserted into the seat 8, the pin 9 protrudes from the exposed face 7 of the ferromagnetic portion 6 and is riveted to form a rivet portion 10.

In accordance with the embodiment shown in FIG. 4, however, the fastening means are interlocking means. In this case, the pin 9 exclusively defines an interlocking fastening. For this purpose, the hole of the ferromagnetic portion 6 has a diameter size corresponding to the section of the pin 9.

The pin 9 may be equal in length to or shorter than the thickness of the ferromagnetic portion 6. In such a case, after the ferromagnetic portion 6 has been inserted into the seat 8, the pin 9 does not protrude with respect to the exposed face 7 of the ferromagnetic portion 6. On the other hand, in the event of the pin 9 being longer than the thickness of the ferromagnetic portion 6, after the latter has been inserted into the seat 8, the pin 9 protrudes with respect to the exposed face 7 of the ferromagnetic portion 6.

In combination thereof, the ferromagnetic portion 6 may have a profiled element with sizes corresponding to the section of the seat 8 so as to further promote the interlocking fastening thereof.

In accordance with a further embodiment of the fastening means, not shown in the figures, the fastening means comprise screwing means, which comprise a threaded hole defined within the seat 8 and a threaded element, of the type of a screw, insertable into the threaded hole through the hole of the ferromagnetic portion 6 and adapted to fasten the latter to the seat 8.

Finally, in accordance with a further embodiment of the fastening means, not shown in the figures, the fastening means comprise adhesive means, which comprise a glue resistant to high temperatures (above 250° C.).

FIG. 5 shows a second embodiment of the plate 1 that differs from the previous one in that the exposed face 7 of the ferromagnetic portion 6 is substantially coplanar with the coupling surface 3.

In other words, in this case, the seat 8 is recessed with respect to the coupling surface 3 and the depth of the same (indicated by reference D1) is substantially equal to the thickness of the ferromagnetic portion 6 (indicated by reference D2).

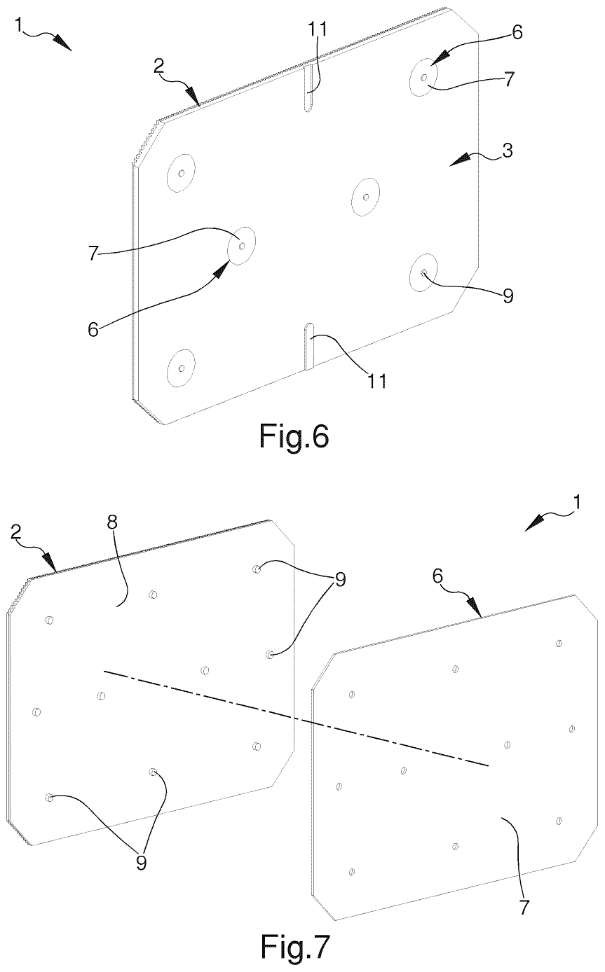

A third embodiment of the plate 1 is shown in FIG. 6, which differs from the previous ones in that the main body 2 further comprises positioning members 11 arranged where the coupling surface 3 is located and adapted to operate in conjunction by interference with relevant positioning portions 24 of the resistance assembly 21.

The positioning members 11 and the positioning portions 24 define a coupling by interference that helps keep the plate in the predefined position.

The positioning members 11 and the positioning portions 24 comprise, e.g., protrusions and recesses which are complementary to each other.

In this case, the ferromagnetic portions 6 may protrude from the coupling surface 3 or coplanar therewith.

FIG. 7 shows a fourth embodiment of the plate which differs from the previous ones in that it comprises an individual ferromagnetic portion 6 having a surface extent corresponding to the coupling surface 3.

In actual facts, the ferromagnetic portion 6 overlaps substantially completely the coupling surface 3. In this case, the seat 8 corresponds to the entire coupling surface 3 and the plate 1 is intended to contact the resistance assembly 21 through the exposed face 7 of the ferromagnetic portion 6.

This solution frees itself from the specific arrangement of the magnetic portions 22 of the resistance assembly 21 and allows for easy adaptation to even different resistance assemblies 21.

According to a further aspect, the present invention also relates to a heating device 20 of machines for the machining of profiled elements made of plastic material.

The heating device 20 can be installed on a machine for the machining of profiled elements made of plastic material and is intended to heat two profiled elements P to be welded at the same time.

The heating device 20 according to the invention comprises:
at least one resistance assembly 21 connectable to an energy source and provided with a pair of main surfaces 25 opposite each other; and
at least two plates 1 according to one or more of the embodiments described above, each associated with a respective main surface 25.

Each of the main surfaces 25 is configured to receive a respective plate 1 and to transmit heat to the latter.

For this purpose, the resistance assembly 21 comprises at least one magnetic portion 22 associated with each of the main surfaces 25 and adapted to operate in conjunction with a respective ferromagnetic portion 6 of the respective plate 1.

As mentioned above, the interaction between the ferromagnetic portion 6 and the magnetic portion 22 generates a magnetic force so as to keep the plate 1 adhered to the resistance assembly 21 and, in particular, to keep the coupling surface 3 in contact with the resistance assembly 21. In this way, the plate 1 is always perfectly planar, thus ensuring optimal heat transfer by the resistance assembly 21 and even contact of the working surface 4 with the profiled element P.

In combination thereof, the heating device 20 may also comprise additional fasteners, of a type known to the industry engineer, located between the plate 1 and the resistance assembly 21.

The resistance assembly 21 comprises a housing 23 made on the main surface 25 and adapted to receive the magnetic portion 22.

The resistance assembly 21 also comprises blocking means adapted to fasten the magnetic portion 22 in the housing 23.

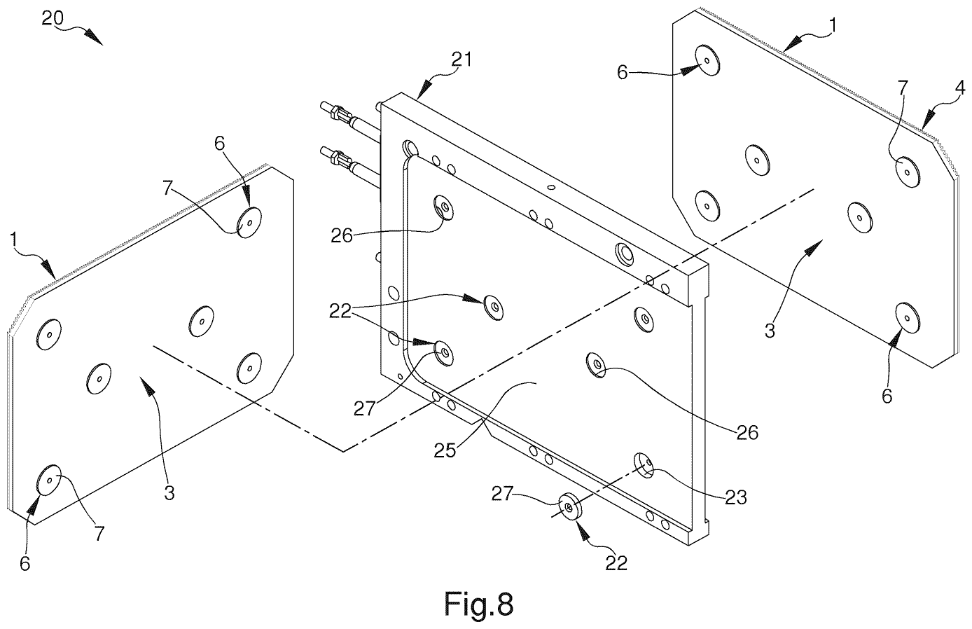

Similarly to the fastening means, the blocking means comprise at least one of: interlocking means, screwing means, adhesive means, rivet means and punching means. Different embodiments of the heating device 20 are shown in FIGS. 8 through 11.

Such embodiments provide for the resistance assembly 21 comprising a plurality of magnetic portions 22.

Similarly to the ferromagnetic portions 6, each of the magnetic portions 22 has a substantially disc-shaped conformation. Specifically, the magnetic portion 22 has a washer conformation, that is, disc-shaped provided with a central hole.

It cannot, however, be ruled out that the magnetic portion 22 may have a different conformation. For example, the magnetic portion 22 may have a polygonal conformation or be of the type of an elongated bar.

The magnetic portions 22 are arranged in various areas of the coupling surface 3 so as to allow optimal distribution of the magnetic forces. Specifically, the magnetic portions 22 are arranged so as to match the ferromagnetic portions 6.

Conveniently, the magnetic portions 22 comprise angular portions, each associated at one angular area of the main surface 25 and at least one central portion associated at a central area of the main surface 25. In the present case, the magnetic portions 22 comprise four angular portions and two central portions.

In FIGS. 8 through 10, a preferred embodiment of the heating device 20 configured to operate in conjunction with the plates 1 in accordance with the first embodiment shown in FIGS. 2 through 4 is shown.

Such a construction solution requires that the housing 23 may define a cavity 26 adapted to receive at least partly the ferromagnetic portion 6, as mentioned earlier.

In detail, the housing 23 is recessed with respect to the main surface 25 and the depth of the housing (indicated by reference D3) is greater than the thickness of the magnetic portion 22 (indicated by reference D4).

The magnetic portion 22 comprises a main face 27, facing outwards, and, between the main face 27 and the main surface 25, is defined the cavity 26 adapted to house the protruding ferromagnetic portion 6 of the plate 1.

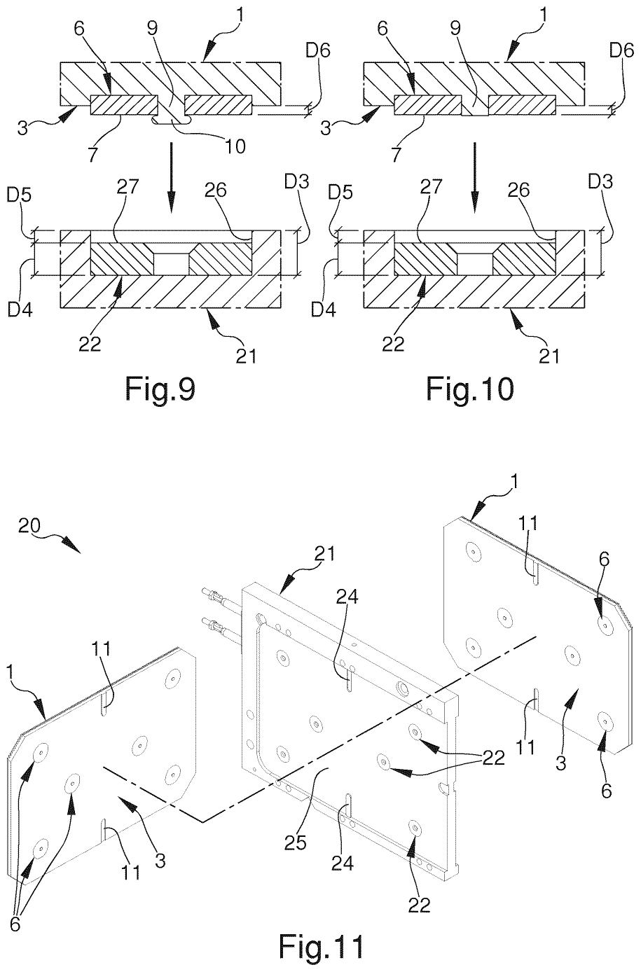

Specifically, as shown in detail in FIGS. 9 and 10, the cavity 26 has a depth (indicated by reference D5) corresponding to the distance between the exposed face 7 and the coupling surface 3 of the plate 1 (indicated by reference D6).

In actual facts, the protrusion defined by the ferromagnetic portion 6 is completely contained in the cavity 26. In this way, the coupling surface 3 is perfectly adhered to the main surface 25 and allows optimal heat transfer from the resistance assembly 21 to the plate 1.

As shown above, the magnetic portion 22 also has a washer conformation, i.e., it is provided with a central hole. The central hole allows the insertion of the pin 9, if it protrudes from the exposed face 7, thus ensuring the contact between the ferromagnetic portion 6 and the magnetic portion 22. For the same reason, as shown in FIG. 9, the central hole can be countersunk and configured to receive the rivet portion 10.

In accordance with a second embodiment of the heating device 20, not shown in detail in the figures, and configured to operate in conjunction with the plates 1 in accordance with the second embodiment shown in FIG. 5, the main face 27 of the magnetic portion 22 is substantially coplanar with the main surface 25. In other words, in this case, the depth of the housing 23 (indicated by reference D3) is substantially equal to the thickness of the magnetic portion 22 (indicated by reference D4).

FIG. 11 shows a third embodiment of the heating device 20 configured to operate in conjunction with the plates 1 in accordance with the third embodiment shown in FIG. 6.

The third embodiment differs from the previous ones in that the resistance assembly 21 comprises positioning portions 24 associated with each of the main surfaces 25 and adapted to operate in conjunction by interference with the positioning members 11 of the respective plate 1.

As shown above, the positioning members 11 and the positioning portions 24 define a coupling by interference that helps keep the plate 1 in the predefined position.

In accordance with a fourth embodiment of the heating device 20, not shown in detail in the figures, and configured to operate in conjunction with the plates 1 in accordance with the fourth embodiment shown in FIG. 7, the resistance assembly 21 comprises an individual magnetic portion 22 on each of the main surfaces 25.

In detail, the magnetic portion 22 has a surface extent corresponding to the main surface 25.

In actual facts, the magnetic portion 22 substantially overlaps the main surface 25. In this case, the housing 23 corresponds to the entire main surface 25 and the resistance assembly 21 is intended to contact the plate 1 through the main face 27 of the magnetic portion 22.

It cannot, however, be ruled out that the resistance assembly 21 may be similar to what described above and have a plurality of magnetic portions arranged in various areas of the main surface 25. In fact, the presence of a ferromagnetic portion 6 with an extent equal to the development of the coupling surface 3 of the plate 1 allows it to be released from the specific arrangement of the magnetic portions 22 of the resistance assembly 21, thus ensuring in any case an optimal adhesion of the plate 1 to the resistance assembly 21.

According to a further aspect, the present invention also relates to a machine 30 for the machining of profiled elements made of plastic material.

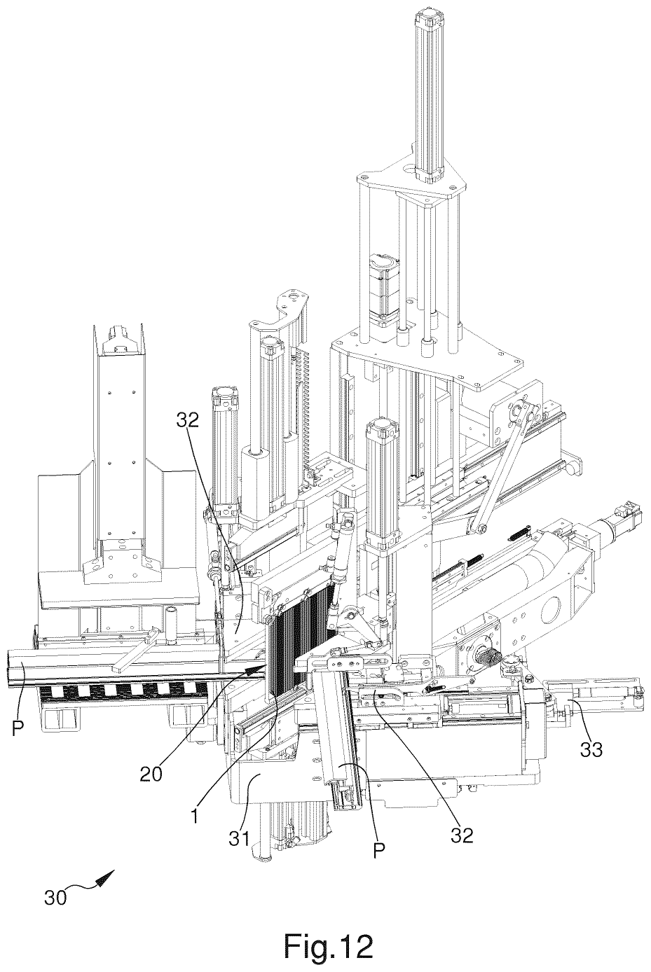

In particular, a machine for the machining of profiled elements for window and door frames is shown in FIG. 12. It cannot, however, be ruled out that the machine 30 is intended for the machining of profiled elements of a different type.

The machine 30 comprises:
at least one base frame 31;
retaining means 32 associated with the base frame 31 and adapted to retain the profiled elements P made of plastic material, which extend along respective longitudinal directions and each provided with at least one area to be welded where at least one relevant end is located, the retaining means 32 being adapted to retain the profiled elements P with the areas to be welded facing each other;
at least one heating device 20 associated with the base frame 31 and adapted to heat the areas to be welded;
movement means 33 associated with the base frame 31 and adapted to mutually move the retaining means 32.

The machine 30 comprises a welding area where the profiled elements P are joined and welded together.

The heating device 20 is movable with respect to the base frame 31 to arrange itself where the welding area is located. At this point, the movement means 33 move the retaining means 32 to bring the profiled elements P in contact with the plates 1 of the heating device 20 and to determine the partial melting of the plastic material.

When finished, the heating device 20 is moved away from the welding area and the movement means 33 move the retaining means 32 to bring the profiled elements P in contact with each other.

According to the invention, the heating device 20 comprises at least one plate 1 according to one or more of the embodiments described above.

As discussed extensively above, the plates 1 in accordance with the invention allow reducing the costs and timelines related to the manufacturing and maintenance of the plate itself and consequently allow reducing the overall cost of the machine 30 and the relevant maintenance costs.

It has in practice been ascertained that the described invention achieves the intended objects and, in particular, the fact is emphasized that the plate according to the invention for heating devices of machines for the machining of profiled elements made of plastic material makes it possible to reduce the costs and timelines related to the manufacturing and/or maintenance of the same.

In addition, this plate provides effective heat transfer from the heating assembly and enables even heating of the profiled element.

1) Plate (1) for heating devices of machines for the machining of profiled elements made of plastic material, said plate (1) comprising a substantially plate-shaped main body (2) provided with a coupling surface (3) which can be coupled to a resistance assembly (21) of a heating device (20) and provided with a working surface (4), opposite said coupling surface (3), intended to contact an area to be welded of a profiled element (P) made of plastic material and provided with a series of grooves (5) and with a coating of at least one non-stick material, wherein it comprises at least one ferromagnetic portion (6) associated with said coupling surface (3), made of at least one ferromagnetic material and adapted to magnetically couple to a corresponding magnetic portion (22) of said resistance assembly (21).

2) Plate (1) according to claim 1, wherein said ferromagnetic portion (6) protrudes from said coupling surface (3), said resistance assembly (21) comprising a housing (23) provided with said magnetic portion (22) and defining a cavity (26) adapted to receive at least partly said ferromagnetic portion (6).

3) Plate (1) according to claim 1, wherein said ferromagnetic portion (6) comprises an exposed face (7), facing outwards, said exposed face (7) being substantially coplanar with said coupling surface (3).

4) Plate (1) according to claim 1, wherein said ferromagnetic portion (6) is of disc-shaped conformation.

5) Plate (1) according to claim 1, wherein said at least one ferromagnetic portion (6) comprises a central ferromagnetic portion (6) associated where a central area of said coupling surface (3) is located.

6) Plate (1) according to claim 1, wherein said at least one ferromagnetic portion (6) comprises a peripheral ferromagnetic portion (6) associated where a peripheral area of said coupling surface (3) is located.

7) Plate (1) according to claim 1, wherein it comprises a plurality of said ferromagnetic portions (6).

8) Plate (1) according to claim 1, wherein said ferromagnetic portions (6) comprise peripheral ferromagnetic portions (6), each associated where a peripheral area of said coupling surface (3) is located and at least one central ferromagnetic portion (6) associated where a central area of said coupling surface (3) is located.

9) Plate (1) according to claim 1, wherein it comprises an individual ferromagnetic portion (6) having a surface extent corresponding to said coupling surface (3).

10) Plate (1) according to claim 1, wherein said main body (2) comprises at least one seat (8) formed on said coupling surface (3) and adapted to receive said ferromagnetic portion (6) and by the fact that it comprises fastening means adapted to fasten said ferromagnetic portion (6) to said main body (2).

11) Plate (1) according to claim 1, wherein said fastening means comprise at least one of: interlocking means, screwing means, adhesive means, rivet means, punching means.

12) Plate (1) according to claim 1, wherein said main body (2) comprises positioning members (11) arranged where said coupling surface (3) is located and adapted to operate in conjunction by interference with relevant positioning portions (24) of said resistance assembly (21).

13) Plate (1) according to claim 1, wherein said main body (2) has a maximum thickness of between 2 mm and 6 mm.

14) Heating device (20) of machines for the machining of profiled elements made of plastic material, wherein it comprises:
at least one resistance assembly (21) connectable to an energy source and provided with a pair of main surfaces (25) opposite each other; and
at least two plates (1) according to claim 1, each associated with a respective main surface (25);
where said resistance assembly (21) comprises at least one magnetic portion (22) associated with each of said main surfaces (25) and adapted to operate in conjunction with a respective ferromagnetic portion (6) of the respective plate (1).

15) Heating device (20) according to claim 11, wherein said resistance assembly (21) comprises at least one housing (23) adapted to receive said magnetic portion (22) and by the fact that it comprises blocking means adapted to fasten said magnetic portion (22) in said housing (23).

16) Heating device (20) according to claim 11, wherein said magnetic portion (22) comprises a main face (27), facing outwards, which is substantially coplanar to said main surface (25).

17) Heating device (20) according to claim 11, wherein said resistance assembly (21) comprises positioning portions (24) associated with each of said main surfaces (25) and adapted to operate in conjunction by interference with said positioning members (11) of the respective plate (1).

18) Machine (30) for the machining of profiled elements made of plastic material, comprising:
at least one base frame (31);
retaining means (32) associated with said base frame (31) and adapted to retain profiled elements (P) made of plastic material, which extend along respective longitudinal directions and are each provided with at least one area to be welded where at least one relevant end is located, said retaining means (32) being adapted to retain said profiled elements (P) with said areas to be welded facing each other;
at least one heating device (20) associated with said base frame (31) and adapted to heat said areas to be welded;
movement means (33) associated with said base frame (31) and adapted to mutually move said retaining means (32);
wherein said heating device (20) comprises at least one plate (1) according to claim 1.
